(19) United States
(12) Patent Application Publication
(10) Pub. No.: US 2026/0269910 A1
(43) Pub. Date: Sep. 10, 2026

(54) COMPRESSION-BASED INTERFERENCE REPORTING

(71) Applicant: Samsung Electronics Co., Ltd., Suwon-si (KR)

(72) Inventors: Gilwon Lee, Prosper, TX (US); Eko Onggosanusi, Coppell, TX (US); Md. Saifur Rahman, Plano, TX (US)

(21) Appl. No.: 19/544,902

(22) Filed: Feb. 19, 2026

Related U.S. Application Data
(60) Provisional application No. 63/768,394, filed on Mar. 7, 2025.
(60) Provisional application No. 63/778,212, filed on Mar. 26, 2025.

(51) Int. Cl. H04B 7/06; H04W 72/0453

(52) U.S. Cl. CPC H04B 7/0626; H04B 7/0658; H04W 72/0453

(57) ABSTRACT

Apparatuses and methods for compression-based interference reporting. A method performed by a user equipment (UE) includes receiving information about a report and a channel state information interference measurement (CSI-IM) reference signal (RS) for an antenna port group and measuring, based on the information, the ZP CSI-RS for the antenna port group. The method further includes determining, based on the information, a coefficient value wₙ for subband (SB) n=0, . . . , N₃−1 and transmitting the report. N₃ is a number of SBs configured for the report. The coefficient value is represented by a frequency domain (FD) compression component and a coefficient component; and

### CROSS-REFERENCE TO RELATED AND CLAIM OF PRIORITY

The present application claims priority under 35 U.S.C. § 119(e) to: U.S. Provisional Patent Application No. 63/768,394 filed Mar. 7, 2025, and U.S. Provisional Patent Application No. 63/778,212 filed Mar. 26, 2025. The above identified provisional patent applications are hereby incorporated by reference in their entirety.

### TECHNICAL FIELD

The present disclosure relates generally to wireless communication systems and, more specifically, to compression-based interference reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to compression-based interference reporting.

In one embodiment, a user equipment (UE) is provided. The UE includes a transceiver configured to receive information about a report and a channel state information interference measurement (CSI-IM) reference signal (RS) for an antenna port group. The UE further includes a processor operably coupled to the transceiver. The processor is configured to measure, based on the information, the CSI-IM RS for the antenna port group; and determine, based on the information, a coefficient value wₙ for a subband (SB) n=0, . . . , N₃−1, where N₃ is a number of SBs configured for the report. The coefficient value is represented by a frequency domain (FD) compression component and a coefficient component. The transceiver is further configured to transmit the report.

In another embodiment, a base station (BS) is provided. The BS includes a processor and a transceiver configured to operably coupled to the processor. The transceiver is configured to transmit information about a report and a ZP CSI-RS for an antenna port group and receive the report. A coefficient value wₙ for a SB n=0, . . . , N₃−1 is based on the information, where N₃ is a number of SBs configured for the report. The coefficient value is represented by a FD compression component and a coefficient component.

In yet another embodiment, a method performed by a UE is provided. The method includes receiving information about a report and a CSI-IM RS for an antenna port group and measuring, based on the information, the CSI-IM RS for the antenna port group. The method further includes determining, based on the information, a coefficient value wₙ for SB n=0, . . . , N₃−1 and transmitting the report. N₃ is a number of SBs configured for the report. The coefficient value is represented by a FD compression component and a coefficient component.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure; and

FIG. 10 illustrates an example method performed by a UE in a wireless communication system according to embodiments of the present disclosure.

### DETAILED DESCRIPTION

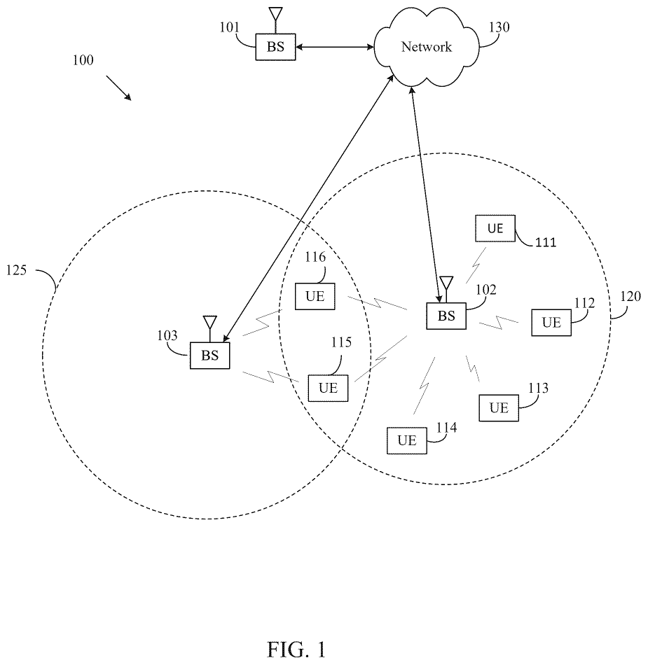

FIGS. 1-10 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 36.211 v18.0.1, “E-UTRA, Physical channels and modulation;” [REF 2]3GPP TS 36.212 v18.1.0, “E-UTRA, Multiplexing and Channel coding;” [REF 3]3GPP TS 36.213 v18.3.0, “E-UTRA, Physical Layer Procedures;” [REF 4]3GPP TS 36.321 v18.3.0, “E-UTRA, Medium Access Control (MAC) protocol specification;” [REF 5]3GPP TS 36.331 v18.4.0, “E-UTRA, Radio Resource Control (RRC) Protocol Specification;” [REF 6]3GPP TR 22.891 v1.2.0; [REF 7]3GPP TS 38.212 v18.4.0, “E-UTRA, NR, Multiplexing and Channel coding;” [REF 8]3GPP TS 38.214 v18.4.0, “E-UTRA, NR, Physical layer procedures for data;” [REF 9]3GPP TS 38.211 v18.4.0, “E-UTRA, NR, Physical channels and modulation.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11 a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for compression-based interference reporting. In certain embodiments, one or more of the BSs 101-103 include circuitry, programing, or a combination thereof to support compression-based interference reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

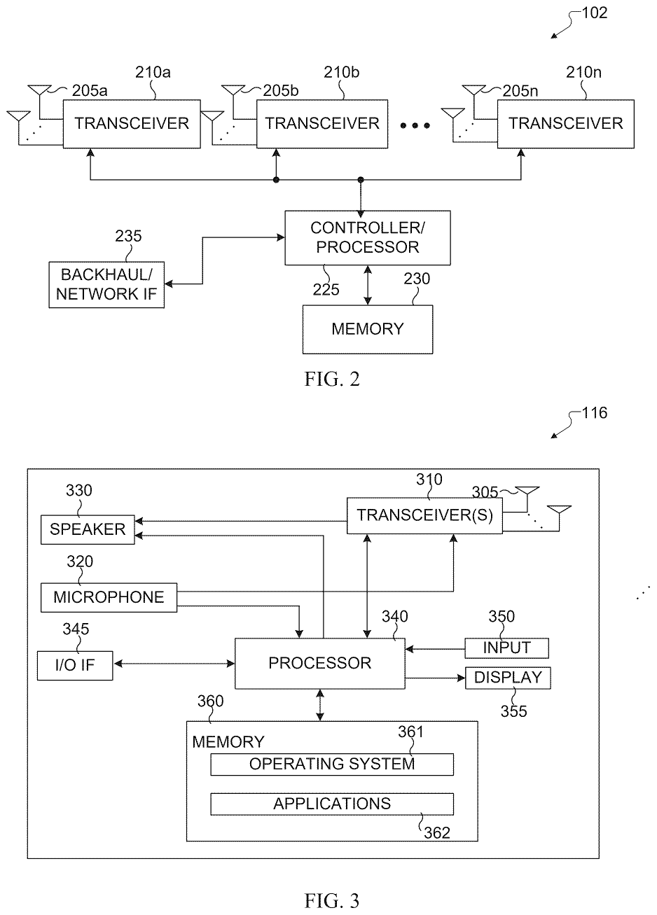

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI configurations in TDD scenarios. Any of a wide variety of other functions could be supported in the gNB 102 by the controller/processor 225.

The controller/processor 225 is also capable of executing programs and other processes resident in the memory 230, such as processes to support compression-based interference reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for compression-based interference reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

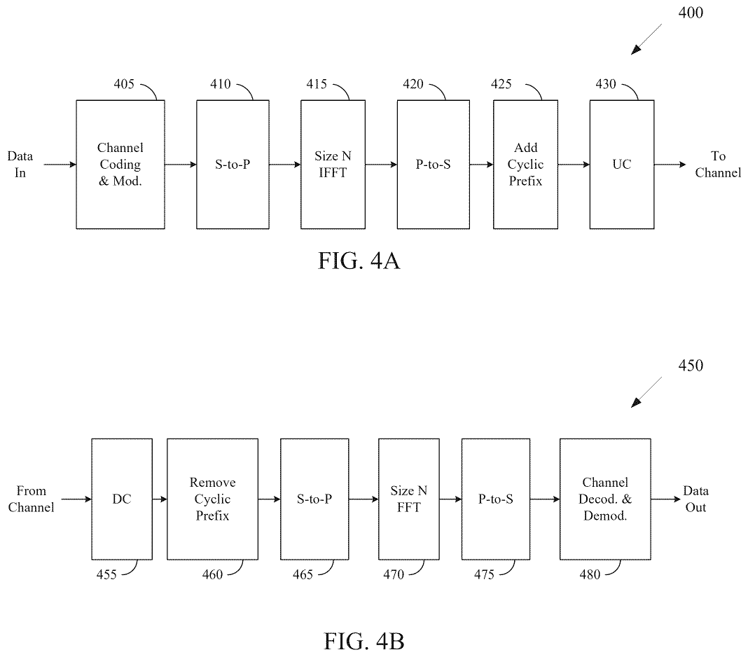

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for compression-based interference reporting.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

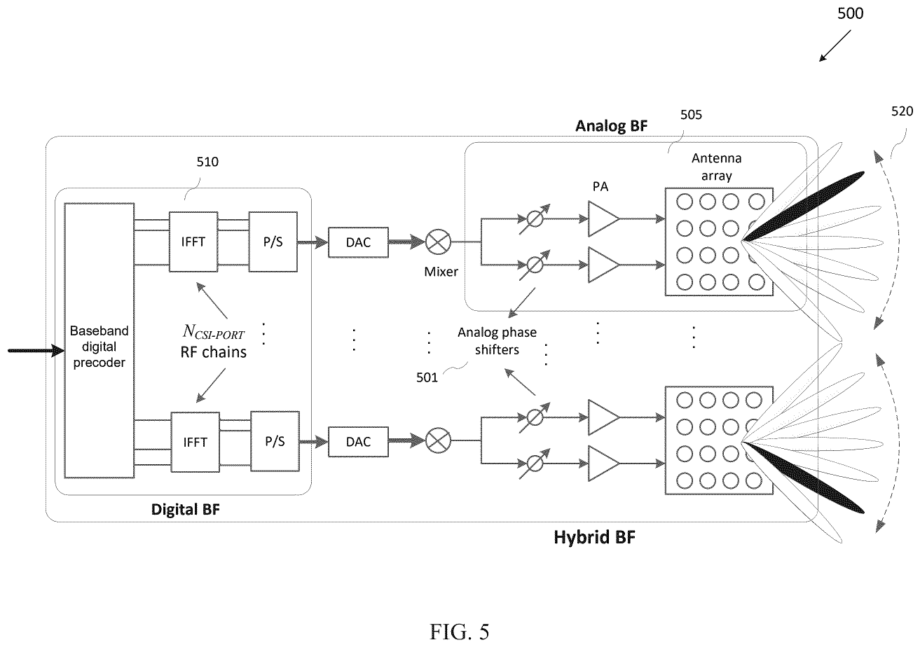

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

A communication system includes a downlink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared Channel (PDSCH). An eNodeB transmits DCI through a Physical DL Control Channel (PDCCH) or an Enhanced PDCCH (EPDCCH)—see also REF 3. An eNodeB transmits acknowledgement information in response to data Transport Block (TB) transmission from a UE in a Physical Hybrid ARQ Indicator Channel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A BCCH is mapped to either a transport channel referred to as a Broadcast Channel (BCH) when it conveys a Master Information Block (MIB) or to a DL Shared Channel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a CRC scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{sc}^{RB}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes

$${N}_{symb}^{UL}$$

symbols for transmitting data information, UCI, DMRS, or SRS. A frequency resource unit of an UL system BW is a RB. A UE is allocated N_{RB} RBs for a total of

$${N}_{RB} \cdot {N}_{sc}^{RB}$$

REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is

$${N}_{symb} = 2 \cdot ( {N}_{symb}^{UL} - 1 ) - {N}_{SRS} , where {N}_{SRS} = 1$$

if a last subframe (or slot) symbol is used to transmit SRS and N_{SRS}=0 otherwise.

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

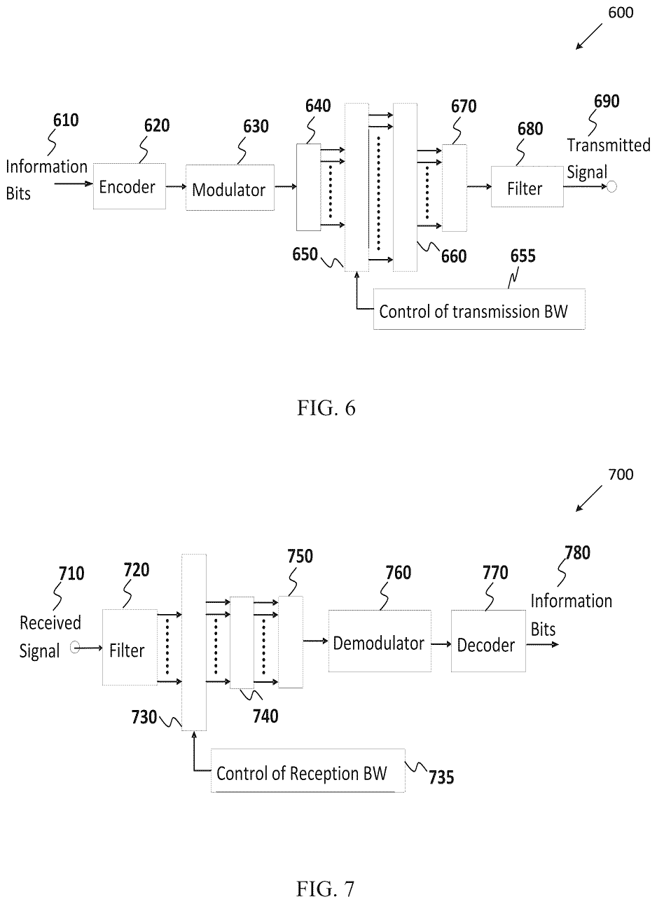

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

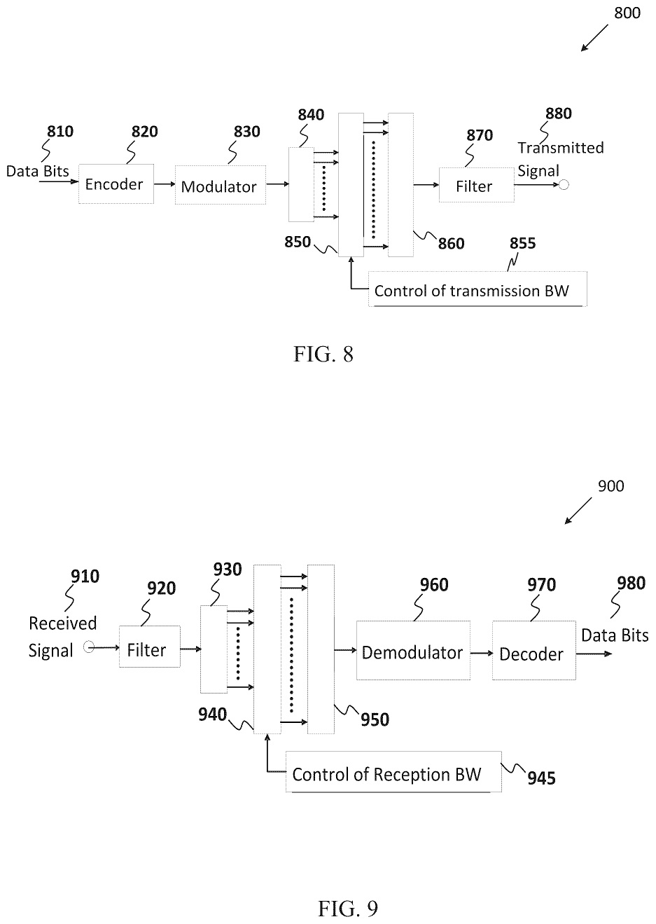

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

| Frequency range | Corresponding |
|---|---|
| designation | frequency range |
| FR1 | 450 MHz-600 MHZ |
| FR2 | 24250 MHz-52600 MHZ |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of radio RF/hardware (HW)-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In a wireless communication system, MIMO is often identified as key feature in order to achieve high system throughput requirements. One of the key components of a MIMO transmission scheme is the accurate CSI acquisition at the eNB (or gNB) (or TRP). For multi-user MIMO (MU-MIMO), in particular, the availability of accurate CSI is essential in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE. In common FDD systems, the CSI feedback framework is ‘implicit’ in the form of channel quality indicator (CQI)/precoding matrix indicator (PMI)/rank indicator (RI) (also CSI reference signal identity (CRI) and layer identity (LI)) derived from a codebook implying SU transmission from eNB (or gNB).

In 5G or NR systems [REF7, REF8], the above-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, embodiments of the present disclosure recognize the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

In Rel. 17 NR, CSI reporting has been enhanced to support the following:
Further enhanced Type II port selection codebook: it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD or/and M ports are selected in FD. The CSI-RS ports in this case are beamformed in SD (assuming UL-DL channel reciprocity in angular domain) or/and FD (assuming UL-DL channel reciprocity in delay/frequency domain), and the corresponding SD or/and FD beamforming information can be obtained at the gNB based on UL channel estimated using SRS measurements. In Rel. 17, such a codebook is supported (which is referred to as Rel. 17 further enhanced Type II port selection codebook in REF8).
Non-coherent joint transmission (NCJT) CSI reporting: When the UE can communicate with multiple TRPs that are distributed at different locations in space (e.g., within a cell), the CSI reporting can correspond to a single TRP hypothesis (i.e., CSI reporting for one of the multiple TRPs), or multi-TRP hypothesis (i.e., CSI reporting for at least two of the multiple TRPs). The CSI reporting for both single TRP and multi-TRP hypotheses are supported in Rel. 17. However, the multi-TRP CSI reporting assume a non-coherent joint transmission (NCJT), i.e., a layer (and precoder) of the transmission is restricted to be transmitted from only one TRP.

In Rel. 18 NR MIMO, the following CSI enhancements are further provided targeting two use cases (coherent joint transmission from multiple TRPs, and high/medium velocity UEs):
Enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off.
CSI reporting enhancement for high/medium UE velocities by exploiting time-domain correlation/Doppler-domain information to assist DL precoding, targeting FR1, as follows:
   Rel-16/17 Type-II codebook refinement, without modification to the spatial and frequency domain basis.
   UE reporting of time-domain channel properties measured via CSI-RS for tracking.

Although Rel-18 CJT CSI can support up to 128 antenna ports by configuring 4 CSI-RS resources each with 32 antenna ports, there is another interest arising to support up to 128 antenna ports using Type-I CSI, which requires smaller feedback overhead than Rel-18 CJT CSI. Currently, a single CSI-RS resource can support up to 32 antenna ports for Type-I single-panel (SP) and multi-panel (MP) CSI. By using multiple CSI-RS resources for Type-I CSI, it is allowed to configure up to 64 antenna ports according to one of the following two schemes:
Two CSI-RS resources each with 32 antenna ports for Rel-17 NCJT (which is Type-I CSI-based).
8 CSI-RS resources each with 8 antenna ports for Type-I SP CSI or Type-I MP CSI.

However, both of the schemes do not offer CSI feedback associated with the entire channel of 64 antenna ports, but are designed for specific use cases, 1) NCJT from two TRP, and 2) one CSI-RS resource selection and reporting associated with the selected CSI-RS resource, respectively. Hence, embodiments of the present disclosure recognize Type-I CSI with more than 32 antenna ports is limited in terms of use cases, and needs some enhancement.

In next generation MIMO systems, the number of antenna ports is expected to increase further (e.g., up to 256), for example, for carrier frequencies in upper mid-band (10-15 GHz); the NW deployments are likely to be denser/more distributed (when compared with 5G NR); and the system is expected to work seamlessly even in challenging scenarios such as medium-high (e.g., 120 kmph) speed UEs, ‘higher-order’ multi-user MIMO.

Similar to common (Rel.15/18 NR) both low-resolution (aka Type I) and high-resolution (aka Type II) CSI reporting for the distributed systems mentioned herein are needed and beneficial depending on use cases and scenarios. Unlike the common, however, it is preferable to have a common framework or components between the two CSI reporting settings, in order to have a simple, future-proof, and scalable solution, thereby making it more feasible in real deployments.

The present disclosure relates to a CSI reporting framework in next generation MIMO systems. In particular, it relates to a compression for the CSI reporting including CQI values or other quantity related to CQI values. Aspects include:
Wf: FD basis selection and reporting utilizing DCT basis for CQI values or quantity related to CQI values
c: coefficient selection and reporting for CQI values or quantity related to CQI values.

The present disclosure also relates to a compression for interference reporting including interference values or other quantity related to interference values. Aspects include:
Wf: FD basis selection and reporting utilizing DCT basis for interference values or quantity related to interference values
c: coefficient selection and reporting for interference values or quantity related to interference values.

Aspects, features, and advantages of the present disclosure are readily apparent from the following detailed description, simply by illustrating a number of particular embodiments and implementations, including the best mode contemplated for carrying out the present disclosure. Embodiments of the present disclosure also capable of other and different embodiments, and its several details can be modified in various obvious respects, all without departing from the spirit and scope of the present disclosure. Accordingly, the drawings and description are to be regarded as illustrative in nature, and not as restrictive. Embodiments of the present disclosure are illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure covers several components which can be used in conjunction or in combination with one another or can operate as standalone schemes.

Each of the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, each of the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include each of the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used. Also, the CSI reporting band can be also interpreted as interference reporting band. For example, an example/embodiment of this disclosure with CSI reporting band can be an example with interference reporting band.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for each of the Mₙ subbands within the CSI reporting band. A CSI parameter is configured with “subband” for the CSI reporting band with Mₙ subbands when one CSI parameter is reported for each of the Mₙ subbands within the CSI reporting band.

In 5G NR, configurable subband sizes (for CQI) depend on a configured bandwidth part (BWP). As seen in the following table in [8], one of two subband sizes can be configured for a given BWP. In one example, SB size depends on a BWP similar to the following table.

| Bandwidth part (PRBs) | Subband size (PRBs) |
|---|---|
| 24-72 | 4, 8 |
| 73-144 | 8, 16 |
| 145-275 | 16, 32 |

In one embodiment, configurable subband size for CQI, PMI, or another reporting quantity (e.g., 5G NR Rel-19 CJTC phase offset reporting or its 6G counterpart) K does not depend on a BWP. The subband size K can be configured from a set S.

In one embodiment, configurable subband size for CQI, PMI, interference (e.g., interference level/power, interference signal power, or interference-related quantity), or another reporting quantity (e.g., 5G NR Rel-19 CJTC phase offset reporting or its 6G counterpart) K does not depend on a BWP. The subband size K can be configured from a set S.

In one example, S includes 1. In one example, S does not include 1.

In one example, S includes 2. In one example, S does not include 2.

In one example, S includes 3. In one example, S does not include 3.

In one example, S includes 4. In one example, S does not include 4.

In one example, S includes 5. In one example, S does not include 5.

In one example, S includes 6. In one example, S does not include 6.

In one example, S includes 7. In one example, S does not include 7.

In one example, S includes 8. In one example, S does not include 8.

In one example, S includes 9. In one example, S does not include 9.

In one example, S includes 10. In one example, S does not include 10.

In one example, S includes 12. In one example, S does not include 12.

In one example, S includes 16. In one example, S does not include 16.

In one example, S includes 32. In one example, S does not include 32.

In one example, S includes 64. In one example, S does not include 64.

In one example, S includes 128. In one example, S does not include 128.

In one example, S includes 256. In one example, S does not include 256.

In one example, S includes an element indicating ‘wideband’ (or another terminology), where the element refers to WB reporting, i.e., one reporting quantity for a whole configured BWP or configured CSI reporting bandwidth. In one example, S does not include an element indicating ‘wideband’ (or another terminology).

In one example, S includes at least one of 1,2,4,8,16,64,128,256, and ‘wideband’.

In one example, S includes a subset of 1,2,4,8,16,64,128,256, and ‘wideband’.

In one example, a unit of an element in a set S is PRB or RB.

In one example, a unit of an element in a set S is multiple of PRB or multiple of RB.

In one example, a unit of an element in a set S is multiple of subcarrier.

In one example, a set S can be according to at least one of the examples above or under one or more embodiments described herein.

In one embodiment, a configurable SB size from a set S should not be larger than a configured BWP or configured CSI or interference reporting bandwidth, or should be less than or equal to a configured BWP or a configured CSI reporting or interference reporting bandwidth.

In one example, a UE is not expected to be configured with a larger SB size than a configured BWP.

In one example, when a larger SB size than a configured BWP or a configured CSI or interference reporting bandwidth is configured for a UE, the UE regards it as ‘wideband’ being configured.

In one embodiment, a maximum number of SBs that can be configured is specified as N_{SB,max}, where N_{SB,max} is fixed to a value or subject to a UE capability, or configured by NW via higher-layer signaling. In one example, a number of SBs can be determined as ceil

$$( \frac{BWP}{SB size} ) ,$$

where BWP indicates a bandwidth-part or a configured CSI or interference reporting bandwidth. Here, ceil(x) refers to the smallest integer that equals to or is larger than x.

In one example, a UE is not expected to be configured with a SB size and a BWP that results in the number of SBs exceeding N_{SB,max}.

In one example, when a SB size and a BWP are configured such that a number of SBs exceeding N_{SB,max}, the UE regards the SB size as the largest SB size for the BWP that results in a number of SBs not exceeding N_{SB,max}.

In one example, N_{SB,max} is fixed to a value, e.g., 16, 18, or 19.

In one example, N_{SB,max} is fixed to a value, e.g., greater than 18.

In one example, N_{SB,max} is fixed to a value, e.g., smaller than 18.

In one example, N_{SB,max} depends on reporting quantity or CSI codebook type.

In one example, N_{SB,max} is subject to a UE capability. In one example, candidate values for the UE capability N_{SB,max} include 18.

In one embodiment, there is no maximum number of SBs being specified. In this case, in one example, a UE can be configured with a SB size regardless of the maximum number of SBs.

In one embodiment, for either a first SB or a last SB (or both of them), the SB size can be not the same as a configured SB size K. In one example, the SB size can be given by or correspond to remainder of

$$\frac{BWP}{SB size} .$$

In one embodiment, a SB size K is applied to both CQI and PMI. In one example, the numbers of SBs for CQI and PMI are the same, where the CQI and PMI include reporting value(s) for each SB.

In one embodiment, a SB size K is applied to PMI, interference (indicator/power, etc), and CQI. In one example, the numbers of SBs for CQI, PMI, and interference are the same, where the CQI, PMI, and interference include reporting value(s) for each SB.

In one example, a SB size K can be different for CQI, PMI, and interference reporting. In one example, another parameter is configured to indicate whether single or multiple PMI is reported in a given SB for CQI reporting or interference reporting (e.g., parameter R in 5G NR or its 6G counterpart).

In one example, a SB size K can be different for CQI, PMI, and interference reporting. In one example, another parameter is configured to indicate whether single or multiple interference values (e.g., similar to PMI) is reported in a given SB for CQI reporting (e.g., parameter R in 5G NR or its 6G counterpart).

In one example, a SB size K can be different for CQI and PMI reporting. In one example, another parameter is configured to indicate whether single or multiple PMI is reported in a given SB for CQI reporting (e.g., parameter R in 5G NR or its 6G counterpart).

In one embodiment CQI values can be compressed with a FD compression component, where CQI values across N₃ SBs (or FD compression units) are compressed by the FD compression component. In one example, N₃ is a number of SBs for CQI reporting (and/or PMI reporting).

For N₃ CQI values, it is compressed via M (or Mv) FD vector selection and M coefficient selection. In one example, the CSI report includes an indicator of M (or Mv) FD vector selection and M coefficient selection.

In this disclosure, M is used but it can be denoted as Mᵥ (similar to 5G NR Rel-16 eType-II CSI or its 6G counterpart).

Although terminology ‘CQI’ values for the N₃ values is used, it should not be limited to CQI only. It can be interpreted as SNR or SINR, RSRP, RSRQ, or other quantity or other value.

For N₃ CQI values, denoted as a vector wCQI that includes the N₃ CQI values, it can be expressed as

$${w}_{CQI} = g ( {W}_{f} c )$$

where W_{f} is a FD-compression basis (e.g., a N₃×M matrix including M FD vectors) and c is a coefficient component (e.g., M×1 coefficient vector including M coefficients), and g(⋅) is a function to map to CQI indices. In one example, the CSI report includes an indicator(s) for selected M FD vectors and an indicator(s) for selected M coefficients.

In another example, for N₃ CQI values, denoted as a vector w_{CQI} that includes the N₃ CQI values, it can be expressed as

$${w}_{CQI} = {W}_{f} c$$

where W_{f} is a FD-compression basis (e.g., a N₃×M matrix including M FD vectors) and c is a coefficient component (e.g., M×1 coefficient vector including M coefficients). In this example, there is no function such as g(⋅) to map to CQI indices.

In one embodiment, a UE is configured to perform interference measurement and/or reporting, where the interference reporting includes indicator(s) for interference value(s) or interference-related quantity(ies). In one example, the configuration can be performed via higher-layer (RRC) signaling. In one example, DL RS reception(s)/measurement(s) (e.g., NZP/ZP CSI-RS, SSB, TRS, a dedicated DL RS, DL DMRS) can be triggered via DCI (or MAC-CE) in an aperiodic manner. In one example, DL RS reception(s)/measurement(s) (e.g., (e.g., NZP/ZP CSI-RS, SSB, TRS, a dedicated DL RS, DL DMRS) can be semi-persistently (or periodically) performed via PDCCH (DCI), MAC-CE, or RRC signaling by indicating activation or deactivation. In one example, DL RS reception(s)/measurement(s) can be periodically performed via RRC signaling. In one example, the interference reporting can be triggered via DCI (or MAC-CE) in an aperiodic manner. In one example, the interference reporting can be semi-persistently (or periodically) performed via PDCCH (DCI), MAC-CE or RRC signaling, by indicating activation or deactivation. In one example, the interference reporting can be periodically performed via RRC signaling.

In one example, the interference reporting can be separately triggered/configured (standalone reporting), not associated with other reporting quantity.

In one example, the interference reporting can be jointly triggered/configured along with other reporting associated with other reporting quantity (e.g., PMI, CQI, or RI).

In one example, the interference reporting is conveyed on a PUSCH.

In one example, the interference reporting is conveyed on a PUCCH.

In one example, the configuration of the DL RS(s) (e.g. CSI-RS) can have no restriction or at least one of the following restrictions.
In one example, only 1-port DL RS can be configured.
In one example, only TRS (CSI-RS for tracking) can be configured.
In one example, only periodic DL-RS can be configured.
In one example, higher density (e.g. 3 REs per port) DL RS for CSI can be configured.
In one example, one slot DL RS measurement can be configured.
In one example, a measurement window (multiple slots) of DL RS measurement can be configured: SP (semi-persistent) CSI-RS or CSI-RS with repetition ON or multiple aperiodic CSI-RS with different offsets (e.g. uniformly separated).

In one example, the quantity value of the interference reporting (interference value) corresponds to (or is associated with or is based on) at least one of the following examples: RSRP, RSRQ (Reference Signal Received Quality), INR (interference-to-noise ratio), interference power, interference strength, interference amplitude, RSSI (Received Signal Strength Indicator), SINR, SNR (signal-to-noise ratio), CLI (cross-link interference).

In one example, the UE can be configured to perform interference reporting per SB (i.e., one interference value per SB).
In one example, one interference value per SB is indicated via an indicator utilizing an alphabet set, where the alphabet set follows one of the examples regarding alphabet set in this disclosure.
In one example, one WB interference value for all SBs is indicated via a first indicator utilizing a first alphabet set and one differential value per SB is indicated via a second indicator utilizing a second alphabet set, where the first and second alphabet sets follow one of the examples regarding alphabet set in this disclosure, respectively.

In one example, the UE can be configured to perform interference reporting per WB (i.e., one value for all configured reporting BW). In one example, one WB interference value for all SBs is indicated via an indicator utilizing an alphabet set, where the alphabet set follows one of the examples regarding alphabet set in this disclosure.

In one embodiment, interference value(s) can be compressed with a FD compression component, where interference values across N₃ SBs (or FD compression units) are compressed by the FD compression component. In one example, N₃ is a number of SBs for interference reporting (and/or PMI/CQI reporting). In one example, another parameter can be used for N₃.

For N₃ interference values, it is compressed via M (or Mv) FD vector selection and M coefficient selection. In one example, the interference report includes an indicator of M (or Mv) FD vector selection and M coefficient selection.

In this disclosure, M is used but it can be denoted as Mᵥ (similar to 5G NR Rel-16 eType-II CSI or its 6G counterpart).

Although ‘interference values’ for the N₃ values is used, it should not be limited to ‘interference values’ only. It can be interpreted as SNR or SINR, RSRP, RSRQ, INR, RSSI, interference power/amplitude/strength or other quantity or other value.

For N₃ interference values, denoted as a vector w_{IN} that includes the N₃ interference values, it can be expressed as

$${w}_{IN} = g ( {W}_{f} c )$$

where W_{f} is a FD-compression basis (e.g., a N₃×M matrix including MFD vectors) and c is a coefficient component (e.g., M×1 coefficient vector including M coefficients), and g(⋅) is a function to map to interference indicator's indices. In one example, the interference report includes an indicator(s) for selected M FD vectors and an indicator(s) for selected M coefficients.

In another example, for N₃ interference values, denoted as a vector w_{IN} that includes the N₃ interference values, it can be expressed as

$${w}_{IN} = {W}_{f} c$$

where W_{f} is a FD-compression basis (e.g., a N₃×M matrix including MFD vectors) and c is a coefficient component (e.g., M×1 coefficient vector including M coefficients).

In one embodiment, a FD compression basis is designed based on a discrete cosine transform (DCT) basis.

In one example, a DCT basis W_{f} can be expressed as follows:

$${[ {W}_{f} ]}_{nm} = \{ \begin{matrix}\frac{1}{\sqrt{{N}_{3}}} , n = 0 \\ \sqrt{\frac{2}{{N}_{3}}} cos \frac{π ( 2 m + 1 ) n}{2 {N}_{3}} , n = 1 , … {N}_{3} - 1\end{matrix} , for m = 0 , … , {N}_{3} - 1.$$

where [A]ₙₘ is an element of row n and column m of A.

In another example, a DCT basis W_{f} can be expressed as follows:

$${[ {W}_{f} ]}_{nm} = \{ \begin{matrix}1 , n = 0 \\ \sqrt{2} cos \frac{π ( 2 m + 1 ) n}{2 {N}_{3}} , n = 1 , … {N}_{3} - 1\end{matrix} , for m = 0 , … , {N}_{3} - 1.$$

where [A]ₙₘ is an element of row n and column m of A.

In one example, for a FD compression, M basis vectors are selected from N₃ row vectors of a DCT basis W_{f} and indicated via an indicator. In one example, the indicator is included in a CSI report (e.g., CSI Part 1 (or Part 2) of two-part CSI).

In one example, for a FD compression, M basis vectors are selected from N₃ column vectors of a DCT basis W_{f} and indicated via an indicator. In one example, the indicator is included in a CSI report (e.g., CSI Part 1 (or Part 2) of two-part CSI).

In one example, for a FD compression, M basis vectors are selected from N₃ row vectors of a DCT basis W_{f} and indicated via an indicator. In one example, the indicator is included in an interference report (e.g., UCI Part 1 (or Part 2) of two-part UCI).

In one example, for a FD compression, M basis vectors are selected from N₃ column vectors of a DCT basis W_{f} and indicated via an indicator. In one example, the indicator is included in an interference report (e.g., UCI Part 1 (or Part 2) of two-part UCI).

In one example, an indicator indicating M basis vectors selected from N₃ vectors of a DCT basis W_{f} is a N₃-bit bit-map indicator.

In one example, an indicator indicating M basis vectors selected from N₃ vectors of a DCT basis W_{f} is a combinatorial indicator with size of

$$⌈ {log}_{2} ( \begin{matrix}{N}_{3} \\ M\end{matrix} ) ⌉ bits , where ( \begin{matrix}N \\ x\end{matrix} ) = \frac{N !}{x ! ( N - x ) !}$$

(i.e., the total number of combinations when choosing k elements among N elements).

In one example, for a FD compression, M−1 basis vectors are selected from N₃−1 row vectors of a DCT basis W_{f} and indicated via an indicator, and a single basis vector from a DCT basis is fixed to be selected (hence no reported). In one example, the indicator is included in a CSI report (e.g., CSI Part 1 (or Part 2) of two-part CSI). In one example, the fixed basis vector is the first-row vector of a DCT basis W_{f}. In one example, the fixed basis vector is a row vector of a DCT basis W_{f}.

In one example, for a FD compression, M−1 basis vectors are selected from N₃−1 row vectors of a DCT basis W_{f} and indicated via an indicator, and a single basis vector from a DCT basis is fixed to be selected (hence no reported). In one example, the indicator is included in an interference report (e.g., UCI Part 1 (or Part 2) of two-part UCI). In one example, the fixed basis vector is the first-row vector of a DCT basis W_{f}. In one example, the fixed basis vector is a row vector of a DCT basis W_{f}.

In one example, for a FD compression, M−1 basis vectors are selected from N₃−1 column vectors of a DCT basis W_{f} and indicated via an indicator, and a single basis vector from a DCT basis is fixed to be selected (hence no reported). In one example, the indicator is included in an interference report (e.g., UCI Part 1 (or Part 2) of two-part UCI). In one example, the fixed basis vector is the first-column vector of a DCT basis W_{f}. In one example, the fixed basis vector is a column vector of a DCT basis W_{f}.

In one example, for a FD compression, M−1 basis vectors are selected from N₃−1 column vectors of a DCT basis W_{f} and indicated via an indicator, and a single basis vector from a DCT basis is fixed to be selected (hence no reported). In one example, the indicator is included in a CSI report (e.g., CSI Part 1 (or Part 2) of two-part CSI). In one example, the fixed basis vector is the first-column vector of a DCT basis W_{f}. In one example, the fixed basis vector is a column vector of a DCT basis W_{f}.

In one example, an indicator indicating M−1 basis vectors selected from N₃−1 vectors of a DCT basis W_{f} is a (N₃−1)-bit bit-map indicator.

In one example, an indicator indicating M−1 basis vectors selected from N₃−1 vectors of a DCT basis W_{f} is a combinatorial indicator with size of

$$⌈ {log}_{2} ( \begin{matrix}{N}_{3} - 1 \\ M - 1\end{matrix} ) ⌉$$

bits.

In one example, W_{f} is an N₃×N₃ matrix (or identity matrix), (i.e., in this case M=N3) hence no reporting quantity is included for the component W_{f}.

In one example, a value of M is configured via an explicit RRC parameter, where the explicit RRC parameter indicates explicitly the value of M.

In one example, a value of M is configured via an implicit RRC parameter, where the implicit RRC parameter (e.g., parameter combination or pᵥ in 5G NR or its 6G counterpart) is used to determine the value of M.

In one example, a value of M is determined by UE and an indicator indicating the value of Mis included in an interference report (e.g., UCI Part 1 (or Part 2) of two-part UCI). The indicator is with size of ┌log₂(x)┘ bits, where x=2, 3, . . . , or N₃.

In one example, a value of M is determined by UE and an indicator indicating the value of Mis included in a CSI report (e.g., CSI Part 1 (or Part 2) of two-part CSI). The indicator is with size of ┌log₂(x)┘ bits, where x=2, 3, . . . , or N₃.

In one embodiment for the M FD basis vector selection, they are selected from a set of (oversampled) DFT vectors. For a given N₃ and oversampling factors O₃, a DFT vector y_{f} can be expressed as follows.

$${y}_{f} = {[ \begin{matrix}1 & {e}^{j \frac{2 π f}{{O}_{3} {N}_{3}}} & … & {e}^{j \frac{2 π f ( {N}_{3} - 1 )}{{O}_{3} {N}_{3}}}\end{matrix} ]}^{T}$$

where f∈{0, 1, . . . , O₃N₃−1}. In one example, O₃ is fixed or configured. In one example O₃=1. In one example, O₃=1 or 4 and can be configured via higher-layer signaling.

In one example, for an indicator indicating the MFD basis vectors, it follows an indication way of FD basis vector selection for 5G NR Rel-16/19 eType-II CSI or its 6G counterpart.

In one example, for one of the M FD basis vectors, it is fixed and corresponds to y₀=[1 1 . . . 1]^{T}. In one example, in this case, M−1 FD basis vectors are selected from a DFT vector set excluding y₀. In this case, for example, f can be selected from {1, 2, . . . , O₃N₃−1} for the example above for the DFT vector set.

In one example, W_{f} is an N₃×N₃ identity matrix, (i.e., in this case M=N3) hence no reporting quantity is included for the component W_{f}.

In one embodiment, LC coefficient vector c is indicated via indicators including amplitude/power indicator(s) and/or phase indicator. The LC coefficient vector c includes M coefficient values. Let denote each of the M coefficients by cᵢ for i=0, 1, . . . , M−1. In one example, the indicators follow at least one of the following (alphabet set) examples.

In one example,

$${c}_{i} = {p}_{i} {e}^{\frac{j 2 π {ϕ}_{i}}{{N}_{P S K}}}$$

where φᵢ ∈{0, 1, . . . , N_{PSK}−1}, and N_{PSK}=2 (for BPSK), N_{PSK}=4 (for QPSK), 8 (for 8PSK), or 16 (for 16PSK), p is an amplitude or power value. In one example, N_{PSK} is fixed, e.g. N_{PSK}=4, or N_{PSK}=2. In one example, p is indicated by amplitude indicator(s). In one example, a phase indicator indicates φᵢ for phase component

$${e}^{\frac{j 2 π {ϕ}_{i}}{{N}_{P S K}}} .$$

In one example, a phase indicator is an 1-bit indicator to indicate either −1 or 1 (i.e., N_{PSK}=2).

In one example, for each of M−1 coefficients (excluding a first coefficient), a phase indicator indicates indicate a phase value. In one example, the phase of the first coefficient is set to

$${e}^{\frac{j 2 π 0}{{N}_{P S K}}} = 1 .$$

In one example, all phase values of M are assumed to be fixed (i.e., known to the gNB) and hence they are not reported via phase indicators.

In one example, pᵢ is indicated by a first (e.g., reference amplitude/power) indicator and a second (e.g., differential amplitude/power) indicator. In one example, a first indicator commonly indicates a value for pᵢ values, and a second indicator indicates a value for pᵢ value specifically. In one example, pᵢ=abᵢ, where a is indicated by the first indicator and bᵢ is indicated by the second indicator. In one example, pᵢ has two components a and bᵢ, where a is indicated by the first indicator and bᵢ is indicated by the second indicator.

In one example, a first indicator indicates a power value(s) and a second indicator indicates a power value(s).

In one example, a first indicator indicates an amplitude value(s) and a second indicator indicates a power value(s).

In one example, a first indicator indicates a power value(s) and a second indicator indicates an amplitude value(s).

In one example, a first indicator indicates an amplitude value(s) and a second indicator indicates an amplitude value(s).

In one example, a first indicator indicates another quantity value(s) (e.g., RSRP, RSRQ, SNR, SINR, INR, RSSI, CLI) and a second indicator indicates an amplitude value(s).

In one example, a first indicator indicates another quantity value(s) (e.g., RSRP, RSRQ, SNR, SINR) and a second indicator indicates a power value(s).

In one example, a first indicator indicates another quantity value(s) (e.g., RSRP, RSRQ, SNR, SINR) and a second indicator indicates another quantity value(s) (e.g., RSRP, RSRQ, SNR, SINR).

In one example, a first indicator indicates another quantity value(s) (e.g., RSRP, RSRQ, SNR, SINR, INR, RSSI, CLI) and a second indicator indicates a power value(s).

In one example, a first indicator indicates another quantity value(s) (e.g., RSRP, RSRQ, SNR, SINR, INR, RSSI, CLI) and a second indicator indicates another quantity value(s) (e.g., RSRP, RSRQ, SNR, SINR, INR, RSSI, CLI).

In one example, a first indicator indicates a power value, and a second indicator indicates another quantity value(s) (e.g., RSRP, RSRQ, SNR, SINR, INR, RSSI, CLI).

In one example, a first indicator indicates an amplitude value, and a second indicator indicates another quantity value(s) (e.g., RSRP, RSRQ, SNR, SINR, INR, RSSI, CLI).

In one example, a first indicator is with size of 5-bit. In one example, its alphabet set includes a multiple of SNR values or SINR values that correspond to a 5-bit CQI table (e.g., 5G NR CQI table or its 6G counterpart).

In one example, a first indicator is with size of 6-bit.

In one example, a first indicator is with size of 7-bit. In one example, its alphabet set includes a 7-bit values to represent RSRP range from x_low to x_high with a 1 dB step size, e.g., x_low=−140 dBm and x_high=−44 dBm (e.g., 5G NR RSRP quantization, or its 6G counterpart).

In one example, a first indicator is with size of 8-bit.

In one example, a first indicator is with size of x-bit where x>8.

In one example, a second indicator is with size of 3-bit. In one example, its alphabet set includes amplitude values of 3-bit amplitude alphabets in 5G NR eType-II CSI codebook or its 6G counterpart.

In one example, a second indicator is with size of 4-bit. In one example, its alphabet set includes amplitude values of 4-bit amplitude alphabets in 5G NR eType-II CSI codebook or its 6G counterpart.

In one example, a second indicator is with size of y-bit, where y>4.

In one example, an alphabet set for an indicator (described in one of the examples in this disclosure) includes uniformly quantized points or ranges for a given range [A,B] in linear scale.

In one example, an alphabet set for an indicator (described in one of the examples in this disclosure) includes uniformly quantized points or ranges for a given range [A,B] in log scale [dB].

In one example, an alphabet set for an indicator (described in one of the examples in this disclosure) includes at least one reserved codepoints.

In one example, an alphabet set for an indicator (described in one of the examples in this disclosure) includes a codepoint that corresponds to ‘out-of-range’, ‘invalid’, or another terminology.

In one example, an alphabet set for an indicator (described in one of the examples in this disclosure) includes a codepoint that corresponds to ‘infinity’ or another terminology.

In one example, a first coefficient value is set to one and hence it is not reported for the corresponding amplitude (e.g., no need to indicate it by a second indicator).

In one example, a strongest coefficient (among M coefficients or M−1 coefficients) is indicated by a strongest coefficient indicator (SCI).

In one example, there is no coefficient indicator (SCI) in the report.

In one example, for a beta value 0<β≤1, M′≤┌Mβ┘ are non-zero coefficients, and among the M coefficients, M′ coefficients are reported. For example, for each of the M′ coefficients, it is indicated and reported according to one of the examples for \tilde{c}ⱼ.

In one example, a M-bit (or N3-bit) bitmap (for each layer) is included in the CSI report, where each bit indicates whether the corresponding coefficient is non-zero or not.

In another embodiment, a M-bit (or N3-bit) bitmap (for each layer) is included in the CSI report, regardless of beta value, where each bit indicates whether the corresponding coefficient is non-zero or not. In one example, the M-bit (or N3-bit) bitmap is in CSI Part 1 and an indicator(s) for cᵢ is in CSI Part 2.

In one example, a M-bit (or N3-bit) bitmap (for each layer) is included in the interference report, where each bit indicates whether the corresponding coefficient is non-zero or not.

In another embodiment, a M-bit (or N3-bit) bitmap (for each layer) is included in the interference report, regardless of beta value, where each bit indicates whether the corresponding coefficient is non-zero or not. In one example, the M-bit (or N3-bit) bitmap is in UCI Part 1 and an indicator(s) for cᵢ is in UCI Part 2.

In one embodiment, for a CSI report including CQI and PMI, a parameter combination for beta and pv (or M) is applied for both CQI and PMI selection.

In one embodiment, for a CSI report including CQI and PMI, a parameter value for beta is independently applied (can be different) for CQI and PMI selection, respectively.

In one embodiment, for a CSI report including CQI and PMI, a parameter value for pv (or M) is independently applied (can be different) for CQI and PMI selection, respectively.

In one embodiment, for a CSI report including CQI and PMI, a parameter combination for beta and pv (or M) is independently (can be different) for CQI and PMI selection, respectively.

In one embodiment, for a report including interference, CQI, and/or PMI, a parameter combination for beta and pv (or M) is applied for the interference, CQI and/or PMI selection.

In one embodiment, for a report including interference, CQI, and/or PMI, a parameter value for beta is independently applied (can be different) for the interference, CQI and/or PMI selection, respectively.

In one embodiment, for a report including interference, CQI, and/or PMI, a parameter value for pv (or M) is independently applied (can be different) for the interference, CQI, and/or PMI selection, respectively.

In one embodiment, for a report including interference, CQI, and/or PMI, a parameter combination for beta and pv (or M) is independently (can be different) for the interference, CQI, and/or PMI selection, respectively.

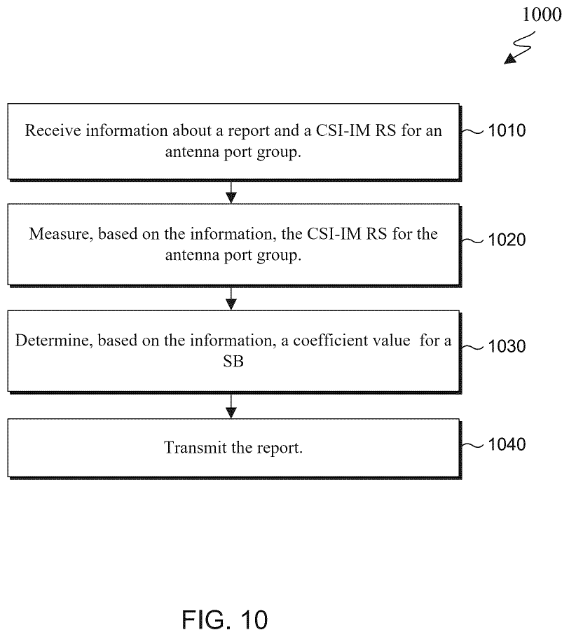

FIG. 10 illustrates an example method 1000 performed by a UE in a wireless communication system according to embodiments of the present disclosure. The method 1000 of FIG. 19 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method 1000 begins with the UE receiving information about a report and a CSI-IM RS for an antenna port group (1010). The UE then measures, based on the information, the CSI-IM RS for the antenna port group (1020). The UE determines, based on the information, a coefficient value wₙ for a SB (1030). For example, in 1030, n=0, . . . , N₃−1, where N₃ is a number of SBs configured for the report, and the coefficient value is represented by a FD compression component and a coefficient component. The UE then transmits the report (1040).

In various embodiments, the coefficient value wₙ for SB n=0, . . . , N₃−1 corresponds to

$$[ \begin{matrix}{w}_{0} \\ {w}_{1} \\ ⋮ \\ {w}_{{N}_{3} - 1}\end{matrix} ] = Wc ,$$

where W is the FD compression component and a N₃×M matrix and c is the coefficient component and a M×1 vector.

In various embodiments, W includes M discrete cosine transform (DCT) basis vectors and the M DCT basis vectors are selected from W_{f}, expressed as

$${[ {W}_{f} ]}_{km} = \{ \begin{matrix}\frac{1}{\sqrt{{N}_{3}}} , k = 0 \\ \sqrt{\frac{2}{{N}_{3}}} cos \frac{π ( 2 m + 1 ) k}{2 {N}_{3}} , k = 1 , … {N}_{3} - 1\end{matrix} , for m = 0 , … , {N}_{3} - 1 ,$$

where [A]ₖm is an element of row k and column m of A.

In various embodiments, one vector of W is set to a first vector of W_{f} and remaining M−1 vectors of W are selected from W_{f} excluding the first vector, where the M−1 vectors are indicated via a combinatorial indicator with

$$⌈ {log}_{2} ( \begin{matrix}{N}_{3} - 1 \\ M - 1\end{matrix} ) ⌉$$

bits and the report includes the combinatorial indicator.

In various embodiments, an i-th element of c is expressed as

$${c}_{i} = {p}_{i} {e}^{\frac{j 2 π {ϕ}_{i}}{{N}_{P S K}}} ,$$

for i=0, . . . , M−1, where pᵢ is selected from an amplitude or power codebook, and φᵢ is selected from a set of {0, 1, . . . , N_{PSK}−1}. In some examples, φ₀ is set to 0, φᵢ∈(0, 1, . . . , N_{PSK}−1 for i=1, . . . , M−1 is indicated by a phase indicator with ┌log₂ N_{PSK}┘ bits, where N_{PSK}=2, and the report includes the phase indicator. In some examples, pᵢ=abᵢ where a is a first amplitude or power value and indicated by a first indicator, bᵢ for i=1, . . . , M−1 is a second amplitude or power value indicated by a second indicator and b₀ is set to 1, and the report includes the first and second indicators. In some examples, the first indicator is with x bits and the second indicator is with y bits, where x≠y.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a report and channel state information interference measurement (CSI-IM) reference signal (RS) for an antenna port group; and
a processor operably coupled to the transceiver, the processor configured to:
measure, based on the information, the CSI-IM RS for the antenna port group; and
determine, based on the information, a coefficient value wₙ for a subband (SB) n=0, . . . , N₃−1, where N₃ is a number of SBs configured for the report,
wherein the coefficient value is represented by a frequency domain (FD) compression component and a coefficient component, and
wherein the transceiver is further configured to transmit the report.

2. The UE of claim 1, wherein the coefficient value wₙ for SB n=0, . . . , N₃−1 corresponds to:
$$[ \begin{matrix}{w}_{0} \\ {w}_{1} \\ ⋮ \\ {w}_{{N}_{3} - 1}\end{matrix} ] = Wc$$
where:
W is the FD compression component and a N₃×M matrix, and
c is the coefficient component and a M×1 vector.

3. The UE of claim 2, wherein:
W includes M discrete cosine transform (DCT) basis vectors, and
the M DCT basis vectors are selected from W_{f}, expressed as:
$${[ {W}_{f} ]}_{km} = \{ \begin{matrix}\frac{1}{\sqrt{{N}_{3}}} , k = 0 \\ \sqrt{\frac{2}{{N}_{3}}} cos \frac{π ( 2 m + 1 ) k}{2 {N}_{3}} , k = 1 , … {N}_{3} - 1\end{matrix} , for m = 0 , … , {N}_{3} - 1$$
where [A]ₖₘ is an element of row k and column m of A.

4. The UE of claim 3, wherein:
one vector of W is set to a first vector of W_{f} and remaining M−1 vectors of W are selected from W_{f} excluding the first vector, where the M−1 vectors are indicated via a combinatorial indicator with
$$⌈ {log}_{2} ( \begin{matrix}{N}_{3} - 1 \\ M - 1\end{matrix} ) ⌉$$
bits, and
the report includes the combinatorial indicator.

5. The UE of claim 2, wherein an i-th element of c is expressed as
$${c}_{i} = {p}_{i} {e}^{\frac{j 2 π {ϕ}_{i}}{{N}_{P S K}}} , for i = 0 , … , M - 1 ,$$
where pᵢ is selected from an amplitude or power codebook, and φᵢ is selected from a set of {0, 1, . . . , N_{PSK}−1}.

6. The UE of claim 5, wherein:
φ₀ is set to 0,
φᵢ∈{0, 1, . . . , N_{PSK}−1} for i=1, . . . , M−1 is indicated by a phase indicator with ┌log₂ N_{PSK}┘ bits, where N_{PSK}=2, and
the report includes the phase indicator.

7. The UE of claim 5, wherein pᵢ=abᵢ where:
a is a first amplitude or power value and indicated by a first indicator;
bᵢ for i=1, . . . , M−1 is a second amplitude or power value indicated by a second indicator and b₀ is set to 1; and
the report includes the first and second indicators.

8. The UE of claim 5, wherein the first indicator is with x bits and the second indicator is with y bits, where x≠y.

9. A base station (BS) comprising:
a processor; and
a transceiver configured to operably coupled to the processor, the transceiver configured to:
transmit information about a report and a channel state information interference measurement (CSI-IM) reference signal (RS) for an antenna port group; and
receive the report,
wherein a coefficient value wₙ for a subband (SB) n=0, . . . , N₃−1 is based on the information, where N₃ is a number of SBs configured for the report, and
wherein the coefficient value is represented by a frequency domain (FD) compression component and a coefficient component.

10. The BS of claim 9, wherein the coefficient value wₙ for SB n=0, . . . , N₃−1 corresponds to:
$$[ \begin{matrix}{w}_{0} \\ {w}_{1} \\ ⋮ \\ {w}_{{N}_{3} - 1}\end{matrix} ] = Wc$$
where:
W is the FD compression component and a N₃×M matrix, and
c is the coefficient component and a M×1 vector.

11. The BS of claim 10, wherein:
W includes M discrete cosine transform (DCT) basis vectors, and
the M DCT basis vectors are selected from W_{f}, expressed as:
$${[ {W}_{f} ]}_{km} = \{ \begin{matrix}\frac{1}{\sqrt{{N}_{3}}} , k = 0 \\ \sqrt{\frac{2}{{N}_{3}}} cos \frac{π ( 2 m + 1 ) k}{2 {N}_{3}} , k = 1 , … {N}_{3} - 1\end{matrix} , for m = 0 , … , {N}_{3} - 1$$
where [A]ₖₘ is an element of row k and column m of A.

12. The BS of claim 11, wherein:
one vector of W is set to a first vector of W_{f} and remaining M−1 vectors of W are selected from W_{f} excluding the first vector, where the M−1 vectors are indicated via a combinatorial indicator with
$$⌈ {log}_{2} ( \begin{matrix}{N}_{3} - 1 \\ M - 1\end{matrix} ) ⌉$$
bits, and
the report includes the combinatorial indicator.

13. The BS of claim 10, wherein an i-th element of c is expressed as
$${c}_{i} = {p}_{i} {e}^{\frac{j 2 π {ϕ}_{i}}{{N}_{P S K}}} , for i = 0 , … , M - 1 ,$$
where pᵢ is selected from an amplitude or power codebook, and φᵢ is selected from a set of {0, 1, . . . , N_{PSK}−1}.

14. The BS of claim 13, wherein:
φ₀ is set to 0,
φᵢ ∈{0, 1, . . . , N_{PSK}−1} for i=1, . . . , M−1 is indicated by a phase indicator with ┌log₂ N_{PSK}┘ bits, where N_{PSK}=2, and
the report includes the phase indicator.

15. The BS of claim 13, wherein pᵢ=abᵢ where:
a is a first amplitude or power value and indicated by a first indicator;
bᵢ for i=1, . . . , M−1 is a second amplitude or power value indicated by a second indicator and b₀ is set to 1; and
the report includes the first and second indicators.

16. The BS of claim 13, wherein the first indicator is with x bits and the second indicator is with y bits, where x≠y.

17. A method performed by a user equipment (UE), the method comprising:
receiving information about a report and a channel state information interference measurement (CSI-IM) reference signal (RS) for an antenna port group;
measuring, based on the information, the CSI-IM RS for the antenna port group;
determining, based on the information, a coefficient value wₙ for subband (SB) n=0, . . . , N₃−1, where N₃ is a number of SBs configured for the report, wherein the coefficient value is represented by a frequency domain (FD) compression component and a coefficient component; and
transmitting the report.

18. The method of claim 17, wherein the coefficient value wₙ for SB n=0, . . . , N₃−1 corresponds to:
$$[ \begin{matrix}{w}_{0} \\ {w}_{1} \\ ⋮ \\ {w}_{{N}_{3} - 1}\end{matrix} ] = Wc$$
where:
W is the FD compression component and a N₃×M matrix, and
c is the coefficient component and a M×1 vector.

19. The method of claim 18, wherein:
W includes M discrete cosine transform (DCT) basis vectors, and
the M DCT basis vectors are selected from W_{f}, expressed as:
$${[ {W}_{f} ]}_{km} = \{ \begin{matrix}\frac{1}{\sqrt{{N}_{3}}} , k = 0 \\ \sqrt{\frac{2}{{N}_{3}}} cos \frac{π ( 2 m + 1 ) k}{2 {N}_{3}} , k = 1 , … {N}_{3} - 1\end{matrix} , for m = 0 , … , {N}_{3} - 1$$
where [A]ₖₘ is an element of row k and column m of A.

20. The method of claim 19, wherein:
one vector of W is set to a first vector of W_{f} and remaining M−1 vectors of W are selected from W_{f} excluding the first vector, where the M−1 vectors are indicated via a combinatorial indicator with
$$⌈ {log}_{2} ( \begin{matrix}{N}_{3} - 1 \\ M - 1\end{matrix} ) ⌉$$
bits, and
the report includes the combinatorial indicator.
